(19) United States
(12) Patent Application Publication
(10) Pub. No.: US 2005/0114530 A1
(43) Pub. Date: May 26, 2005

(54) Method and apparatus for granting selective access to a wireless communication device

(76) Inventors: Ruchi Mangalik, Glenview, IL (US); John D. Bruner, South Barrington, IL (US); Steve R. Bunch, Harvard, IL (US); Bilal Saleh, Lombard, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/721,370

(22) Filed: Nov. 25, 2003

(51) Int. Cl. G06F 15/173; G06F 11/30

(52) U.S. Cl. 709/229; 713/201

(57) ABSTRACT

A third party or third party device 110, 116 makes an access request to a wireless communication device 100. The wireless communication device 100 generates a token specifying an identity for use by the device when making a connection request. The wireless communication device 100 also specifies alright wherein the right is for access to a capability of the wireless communication device 100. When a connection request is received the token for identity verification is checked and access is allowed according to the rights specified if the identity is verified. Access via the user interface 208 is also granted in the same fashion. A wireless communication device 100 arranged for implementing this method is also described.

### TECHNICAL FIELD

This invention relates in general to communication systems, and more specifically to a method and apparatus for granting selective access to a wireless communication device.

### BACKGROUND

Cellular phones and other wireless communication devices that allow connection to services and processes executing within the wireless communication device exist. When such connections are made the wireless communication device is exposed to attack, unwanted alteration, and/or service interruptions caused by viruses, hackers, inadvertent misuse, malicious or poor software and other mechanisms. These potential undesired side effects can limit the usefulness and acceptance of allowing third party access into wireless communication devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a system diagram of a communications system for granting selective access to a wireless communication device;

FIG. 2 depicts, in a simplified and representative form, a block diagram of a wireless communication device arranged for granting selective access;

FIG. 3 is a method for granting a connection in a wireless communication device; and

FIG. 4 is an alternate method for granting a connection in a wireless communication device.

### DETAILED DESCRIPTION

In overview, the present disclosure concerns wireless communication devices that are capable of granting connections to outside parties and more particularly limiting those connections to a defined subset of the services or features of the wireless communication device.

Various inventive concepts and principles embodied in methods and apparatus for the management and application of sharing of services and/or features of a wireless communication device with a third party are discussed. Beyond a single third party, the management of groups of users is also discussed and described. The wireless communication devices of particular interest are those that are enabled for Internet Protocol (“IP”) data communications, although an embodiment for utilizing the wireless communication device's user interface is also discussed.

As further discussed below various inventive principles and combinations thereof are advantageously employed to manage access to a wireless communication device by authorizing a connection to the device either before a request is received or while a request is pending. Such an authorization may take the form of a simple approval or involve more complex methods such as generating tokens for use in later verification.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

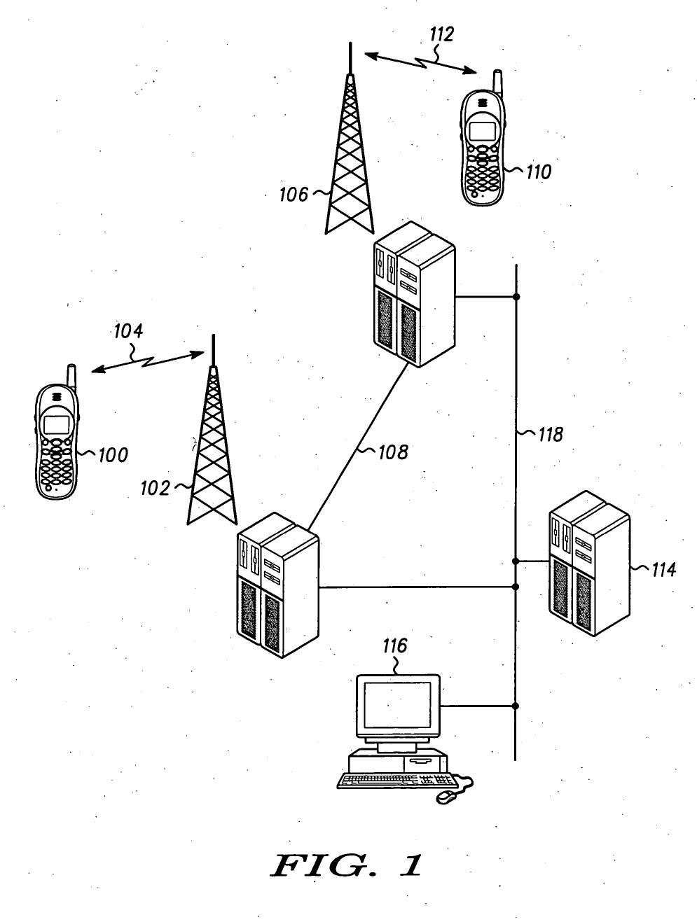

Referring to FIG. 1, a system diagram of a communications system for granting selective access to a wireless communication device will be discussed and described. A wireless communication device 100 capable of either voice or data connections, often both, communicates to a first wireless communication infrastructure 102 via a wireless link 104. Further communication is enabled via the same or a second wireless communication infrastructure 106 that is connected via a communication link 108. The communication link 108, if present or needed, may be a landline, satellite, or other known connection. The second wireless communication infrastructure 106 may connect to a second wireless communication device 110 over a second wireless link 112.

Communication may also be established between the wireless communication device 100 and a server 114 or a computer 116 via a network 118, such as the Internet. The server 114 may be a gaming server, corporate enterprise server or other source of data or services. The computer 116 may be a corporate computer for providing data or a simple home user device for connecting to a game on the wireless communication device 100. Similarly, the second wireless communication device 110 may connect to the wireless communication device 100 to share certain information or connect to a process for some entertainment purpose. In the case where the server 114 supports gaming or another service, the second wireless communication device 110 may also be connected to the server 114 where the server 114 acts as an intermediary for the purpose of locating, connecting, and supporting a shared process, for example, a game. This may or may not include security services such as a connection to a certificate authority (not shown), managing short lived certificates, verification tokens, time outs, etc.

The wireless communication devices 100,110 and their supporting communication infrastructures 102,106 are known and available. The wireless communication devices may support both voice and data communications and are available from suppliers such as Motorola. The communication infrastructures 102, 106 are typically cellular networks and are available from suppliers such as Motorola. The server 114 may be any of several servers running, for example, UNIX or Windows™ operating systems. The server applications may be written in Java, C++ or another language.

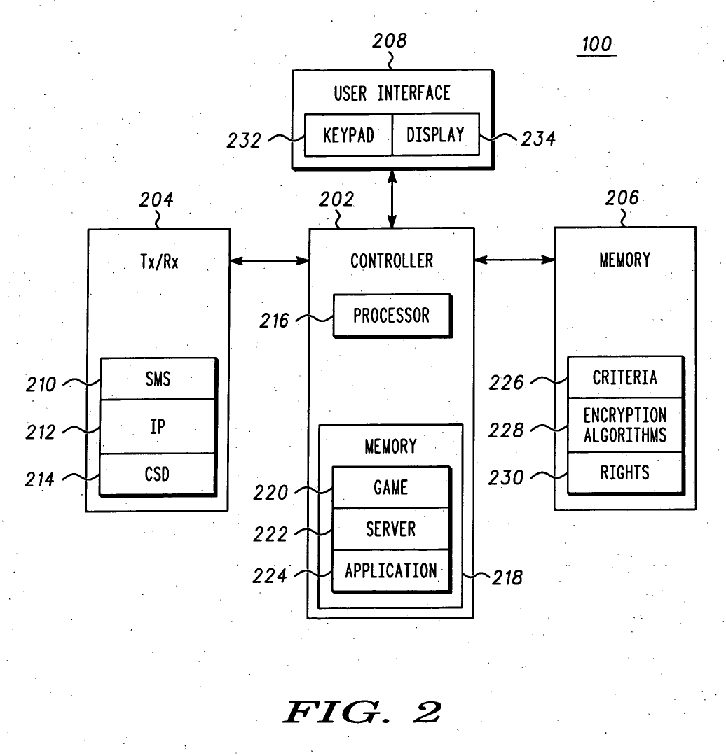

FIG. 2, a block diagram of a wireless communication device 100 arranged for granting selective access, will be discussed and described. A controller 202 is coupled to a transceiver 204, a memory 206, and a user interface 208. The transceiver 204 may support a plurality of communication protocols, for example, short message service 210 (“SMS”), Internet Protocol 212 (“IP”), or circuit switched data 214 (“CSD”). The IP 212 connectivity may be of Wireless Application Protocol (“WAP”) that is specific to some carriers and provides data service in an IP fashion.

The controller 202 further comprises a processor 216 for executing instructions to carry out specific tasks in the wireless communication device 100 as may be stored in internal memory 218 in the controller. Such tasks may include the basic operations of the wireless communication device 100 such as making and receiving voice calls and data communications. Additional applications may include games 220, server 222 or hosting functions, or other applications 224 that may be shipped with the wireless communication device 100 or downloaded and stored with the wireless communication device 100 by the user. In some configurations, external memory 206 may be used instead of or supplemental to the internal memory 218 for storing operating system instructions, other applications, or additional program data. Such additional data may include access criteria 226, encryption algorithms 228 and access rights 230. The user interface 208 typically includes a keypad 232 or touch screen input and a display 234.

In operation, the wireless communication device 100 is arranged and constructed for permitting selective access to the wireless communication device 100 by third parties making such a request for access. The user interface 208 is used for specifying a criterion for permitting the access, or the criterion may be pre-loaded into the memory 206. The criterion, being at least one of several possible criteria 226, may be a password, a coded message or signal, an origin identifier such as a caller identification, a digitally signed certificate or other mechanism. The transceiver 204 sends and receives communications that may include the access request, a response to the access request and a connection request.

The controller 202 typically manages the access request, approvals, responses and the connection procedures. Specifically, in one embodiment, when an access request is received, the controller 202 will grant access to the requested service when presented with information that satisfies the required criterion. In an exemplary embodiment, a third party on the second wireless communication device 110 or PC 116 discovers a game hosted on the wireless communication device 100 through an intermediary, such as a game server 114. Other methods to discover the availability of a game exist, including but not limited to, a broadcast from the owner, an email, or a posting to a bulletin board. The third party sends an access request to the game or game server process running on the wireless communication device 100. The access request message can be processed by the controller 202. A message may be posted to the user interface 208 stating that an access request has been received. The user can then respond either approving the request or rejecting it. If the user approves the request, he or she may specify what criterion to use for authenticating the connection. In another embodiment, the criterion may be selected by the controller 202 based on a predetermined standards such as risk or the amount of resource likely to be consumed, and the access request granted or refused without interaction with the user interface 208.

The access request can also be received as part of the actual connection request, that is, while the connection is pending. Because the access request and the connection request can be received separately and asynchronously they can be served by different communication channels or protocols. The request can be received, for example, via a circuit switched data connection, a short message service message, an email or an Internet Protocol/WAP connection. The connection, if granted, can be made over the same or a different channel, for example, a circuit switched connection, a short message service connection, or an Internet Protocol connection. In the case where a connection is granted while the request is pending, it is possible that no further authentication is required if access is approved.

If access is requested separately and prior to the actual connection it may be desirable for the controller 202 to specify a criterion for the later connection attempt. The criterion may be a requirement for the requesting device 110,116 to provide an identification of some form, such as, a simple caller identification provided by the carrier. In another embodiment, the controller 202 may respond to the requesting device 110, 116 with a response that the access request has been approved. The response may include a token that the controller 202 has or generates. In general, the connection allowed will enable only a subset of the available features or processes in the wireless communication device 100. When this connection presents a lower level of threat, due to the nature of the connection or the specific service being accessed, a low security token, such as a random number can be provided. The random number does not prevent sharing of the token with other devices, but the use of a random number can be set up for a single use, and would provide some level of assurance that the connection is from the device that requested it.

Increasing levels of risk or security needs may make it desirable to have higher assurance tokens. One example may be a token coded or embedded with information such as the caller ID of the requestor that can be decoded when received and matched to the incoming connection request. Another embodiment may be similar to the first but where the data is encrypted using a secret key and algorithm 228 available only to the controller 202. Such data may also include a range of times when the connection is valid, a duration for the connection, or other criteria that can automatically limit the connection without the need to burden the memory 206 by storing such criteria 226 in the wireless communication device 100. This is particularly useful for conserving internal memory 206, 218 resources. Storing detailed information about each of many third parties who may be allowed access can create a burden on the internal memory 206, 218. Using the token to store relevant information about the potential connection moves this burden from the wireless communication device 100 to a potential connecting device such as another wireless communication device 110 or other computer such as 116.

In applications where the highest levels of security need to be enforced a public key infrastructure can be used to create signed tokens traceable to a certificate authority. For example, a signed token from the wireless communication device 100 may be given to the requesting device that must in turn re-sign the token with its private key and supply it back to the wireless communication device 100 for evaluation using the certified public key of the requesting device. Encryption algorithms 228 for any of the above can be stored in the memory 206.

The access granted may depend on the type of request. Access may be requested for a game, a server or an application. The game may be a simple two-player “run and shoot” game. The application may be more complex such as an on-line bidding system. In one embodiment, the wireless communication device 100 may be a host for data such as real time photographs of an event or scene and may act as a server for hosting connections from a number of clients.

In an embodiment where a number of criteria are stored for allowing access to, for example, a game, the user of the wireless communication device 100 may revoke a previously approved access by simply deleting a criterion associated with that game, a third party, or a group of third parties identified with that criterion. For example, there may be a case where all requestors to a multi-user game are given a numerical token having all or some of the digits in common. If the user decides to no longer participate, the access can be revoked by deleting the number from the criteria memory 226 via a user interface 208 dialog. If the numerical token is coded, groups or even single users can be excluded by masking or keying portions of the numerical token.

In another embodiment, the notification from the wireless communication device 100 to the requestor may also include an invitation for the requestor to respond via email, either as a confirmation or for another business purpose. Similar to the above case, the use of a coded number, including a token or encrypted token, can be used by the wireless communication device 100 and a user thereof to sort or categorize responsive emails for the purpose of preparing for a connection, removing a previously approved request, marketing or other group purpose.

In another embodiment, the access request, approval and connection request are all accomplished via the user interface 208. For example, an owner of a wireless communication device 100 may wish to allow a third party access to the wireless communication device 100 for the purpose of playing a game. The owner may authorize an access to a particular game, or other application and then select or receive a code for the third party to use when accessing the wireless communication device 100. At a later time, within any preset expiration period, the third party can enter the code and be allowed to use the portion of the full services of the wireless communication device 100 so designated. Of interest may be the case where the owner enables a game for the third party but does not enable use of the voice or other communication services of the wireless communication device 100.

The components of the wireless communication device 100 are known and available. The controller 202 may be or include a digital signal processor and is available from manufacturers such as Motorola. The transceiver 204 is common to wireless communication devices, especially cellular phones and may be a chip set or combination of chips and discrete components available commercially from different vendors depending on the frequency band and over the air technology employed. The keypad 232, display 234 and other components of the user interface 208 are commercially available. The memory 206 may comprise both volatile and non-volatile memory and is available from a number of semiconductor manufacturers or distributors.

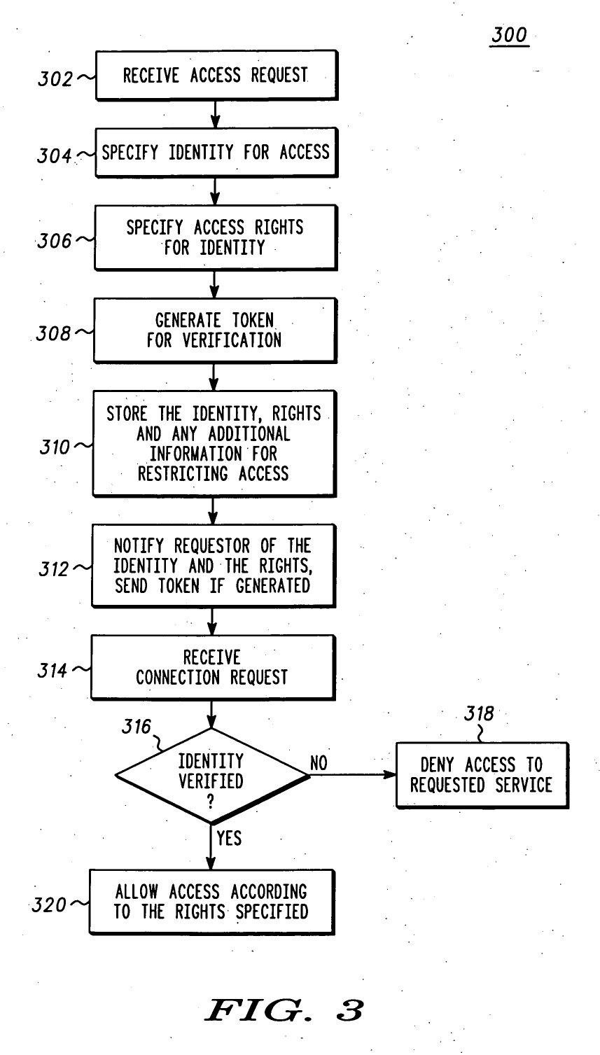

FIG. 3, depicting a method for granting a connection in a wireless communication device, is discussed and described. In one embodiment the method covers generally an access request followed by a connection request. When the access request is approved and an identifier is generated, a subsequent connection request can be authorized using the identifier and a connection made to the preapproved service. The access request can be received 302 via one of a circuit-switched connection, a short message service message, an Internet protocol connection or the user interface 208 of the wireless communication device. In another embodiment, the user initiates the action by selecting or more parties for allowing access to the wireless communication device 100. In this embodiment, there is no initial request 302, but a user initiated assignment of identity and rights. An identity is specified 304 for a user or device for accessing the wireless communication device 100. For example, a device 110,116 requesting access to the wireless communication device 100 may be assigned an identity either using some indicator from the requesting device, such as a caller identification or one created by the wireless communication device 100. Once a decision has been made to grant access, either via a user interface 208 dialog or programmatically in the wireless communication device 100 the access rights for that identity can be specified 306. Again, this can be done via a user interface 208 dialog or programmatically. Access may be given to all the services of the wireless communication device 100 but more often to a portion being a subset of the services available. For example, access may be restricted to a particular game or games, a server process, and an application program.

A token or identifier may be selected or generated 306 for use when a subsequent connection is received. In one embodiment a simple caller identification can be used, in another embodiment a token representing the identity can be created and sent to the requestor along with a notification of the rights granted. The token is used by the requesting device when connecting to the specified service or method in the wireless communication device 100. This can be one of several identifiers, such as a random number, clear data, encrypted data, or a certificate. The random number and clear data, perhaps a symbol representing, the rights granted, do not offer substantial protection from a fraudulent device trying to gain access but can limit the number of devices trying to gain access, especially if the token is only allowed to be presented once or a limited number of times. Encrypted data can also be used to encode certain information about the requesting device, such as a caller identification, or may include information regarding the rights granted or an expiration date. When received back from the requesting device 110, 116 the wireless communication device 100 can decrypt the token and extract the relevant information to confirm the continued availability of the offer for service access. A certificate may also be used as the token. In this case the certificate may contain signed information known to the wireless communication device 100 and countersigned by the private key of the requesting device.

The wireless communication device 100 may store 310 in memory 206 the identity, the rights and any supplemental information, such as caller identification, encryption keys or expiration date/time. The supplemental information may contain information used by the wireless communication device 100 for restricting access to the wireless communication device 100 or a process thereof, such as the caller identification, encryption keys, a process identifier or IP socket number, a date, a time period, a duration, a version identifier, or a group identifier. The version identifier can be used to ensure only compatible versions of software are allowed to connect, for example, to a game. The group identifier can be used for allowing or excluding access to a group of users. The group identifier may be used to exclude users based on a particular characteristic, such as a country code.

After an initial request for access has been received, approved, and in some cases, information sent to the requesting device, the wireless communication device 100 is prepared to receive a connection request from the requesting device. When the connection request is received 314, any identity information available, either embedded in the connection message or stored in the wireless communication device 100 is verified 316. If the identity verification fails or the service being requested does not match the preauthorization the “no” branch from 316 is followed and the connection request is denied 318. If the identity is verified, the “yes” branch from 316 is followed and the connection to the requested service is granted 320.

When the wireless communication device 100 receives a connection request from, for example, another wireless communication device 110, a computer 116 or a game server 114 the connection request can be accompanied by a verification of identity as discussed above. Typically any of a caller identification, the token supplied during the initial request, or a combination of caller identification and the token. One model for the connection can be a IP socket connection to a communication handler in a Java™ program. The Java environment, using a concept called a “sandbox,” allows well constructed programs to operate relatively securely by compartmentalizing the program's execution from other programs and the operating system.

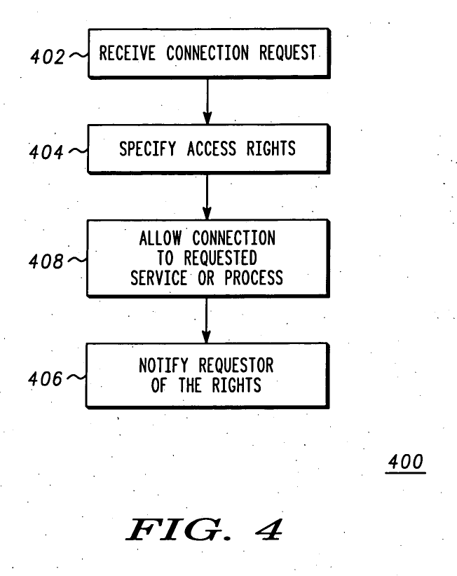

Referring to FIG. 4, an alternate method for granting a connection in a wireless communication device 100 will be discussed and described. The previous embodiment of FIG. 3 shows how a connection can be granted when an access request is first processed and a response sent back to the requesting device. In another embodiment a connection request is received 402 and access rights are specified 404. A caller identification may be used in the process for deciding to allow the connection. However, caller identification or another identifier may not be required if, for example, the access requested is of low security interest or the connection request coincides with an expected connection request. The connection request can be immediately granted and the connection made 406. A notification can be sent 408 to the requester, in most cases over the connected channel. Notification via another mechanism such as SMS is also possible.

The processes and apparatus discussed above an the inventive principles thereof are intended to and will alleviate problems caused by prior art connection mechanisms to wireless communication devices supporting third party access. Using these principles of pre-approval of specific connection requests and restricting connections to specific services of the wireless communication device 100 will improve the security of third party access and increase the beneficial use of wireless communication devices for personal, business, and entertainment purposes.

The ability to assign differing levels of security to the access request and apply them to a subsequent connection request will help to assure that security measures appropriate to the risk are available. This allows third party access without creating undue vulnerability of the wireless communication device 100 but also without burdening the wireless communication device 100 with cumbersome and potentially costly security measures.

Further, the ability in one embodiment to allow access to the wireless communication device 100 for using a subset of its services, in some cases excluding the voice or other messaging services, allows an owner to share the wireless communication device 100 with a child or friend without the fear of unwanted communication.

Various embodiments of methods and apparatus for managing third party access to services of a wireless communication device 100 have been discussed and described. It is expected that these embodiments or others in accordance with the present invention will have application to many kinds of communication equipment where a user may wish to manage access requests individually and with varying levels of security. Using the inventive principles and concepts disclosed herein advantageously allows or provides for improved control in determining access to a wireless communication device 100 as well as mechanisms for revoking pending access requests individually or in groups.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally; and equitably entitled.

1. A method for allowing an access to a wireless communication device comprising:
specifying an identity for accessing the wireless communication device;
specifying a right for the identity wherein the right is for the access to a capability of the wireless communication device;
receiving a connection request; and
allowing the access according to the right when presented with a verification of the identity.

2. The method of claim 1 further comprising:
receiving an access request prior to specifying the identity.

3. The method of claim 1 further comprising:
storing the right and the identity.

4. The method of claim 3 wherein the storing the right further comprises:
storing an additional information with the identity, the additional information for restricting access upon receiving the connection request.

5. The method of claim 4 wherein the additional information is one of a date, a time period, a duration, a version identifier, and group identifier.

6. The method of claim 1 further comprising:
notifying a requestor of the right and the identity.

7. The method of claim 1 wherein the allowing the access further comprises:
using for the verification of the identity one of a caller identification, a token and the caller identification combined with the token.

8. The method of claim 1 further comprising:
generating a token for use as the verification of the identity, wherein the token is one of a random number, a clear data, an encrypted data, and a certificate.

9. The method of claim 1 wherein the access request further comprises:
receiving the access request from a remote device.

10. The method of claim 1 wherein the specifying the right further comprises:
specifying the right to access one of a game, a server process, and an application program.

11. The method of claim 1 wherein the specifying the identity further comprises:
specifying the identity one of prior to the connection request and while the connection request is pending.

12. The method of claim 1 wherein the receiving the access request further comprises:
receiving the access request via one of a circuit-switched connection, a short message service message, an Internet protocol connection and a user interface of the wireless communication device.

13. A wireless communication device arranged and constructed for permitting an access to the wireless communication device comprising:
a user interface for specifying a criterion for permitting the access by a third party;
a transceiver for sending and receiving a communication; and
a controller coupled to the user interface and transceiver for permitting the access to the device when the criterion is satisfied by a connection request.

14. The wireless communication device of claim 13 wherein the controller is further operable to notify the third party that the access is approved.

15. The wireless communication device of claim 14 wherein the notification includes an invitation to respond by electronic mail.

16. The wireless communication device of claim 13 wherein the controller uses a caller identification as the criterion.

17. The wireless communication device of claim 13 wherein the controller supplies the criterion for use by the third party, the criterion comprising one of a random number, a coded data, an encrypted data, and a signed token.

18. The wireless communication device of claim 13 further comprising a memory for storing the criterion.

19. The wireless communication device of claim 18 wherein the access is revoked for a third party by deleting the criterion corresponding to the third party.

20. The wireless communication device of claim 13 wherein the access is permitted to one of a game, a server, and an application.

21. The wireless communication device of claim 13 wherein specifying the criterion is performed prior to the incoming request or after the connection request is received.

22. The wireless communication device of claim 13 wherein the connection request is received by one of a circuit switched connection, a short message service connection, an electronic mail and an Internet Protocol connection.

23. The wireless communication device of claim 13 wherein the connection request is received by the user interface, the criterion having been specified prior to the connection request.

24. The wireless communication device of claim 13 wherein the access is permitted over one of a circuit switched connection, a short message service connection, an Internet Protocol connection, and the user interface.

25. A wireless communication device arranged and constructed for supporting multiple users comprising:
a user interface for designating a first user and a second user wherein the second user is authorized for a portion of a services set of the wireless communication device available to the first user; and
a controller for determining when one of the first and second users is authorized to access the wireless communication device, wherein the controller enforces access to the services set corresponding to the one of the first and second users.

26. The wireless communication device of claim 25 wherein the portion of the services set available to the second user does not include voice communication.
